(19) United States
(12) Patent Application Publication
(10) Pub. No.: US 2010/0272145 A1
(43) Pub. Date: Oct. 28, 2010

(54) VECSEL-PUMPED SOLID-STATE LASER

(75) Inventors: Ulrich Weichmann, Aachen (DE); Holger Moench, Vaals (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/747,524

(22) PCT Filed: Dec. 16, 2008
(86) PCT No.: PCT/IB2008/055320

§ 371 Date: Jun. 11, 2010

(30) Foreign Application Priority Data
Dec. 19, 2007 (EP) 07123571.7

(51) Int. Cl. H01S 3/0941

(52) U.S. Cl. 372/75

(57) ABSTRACT

The present invention relates to a solid-state laser system constituted bya solid-state laser whichis optically pumped by a vertical extended cavity surface emitting laser (VECSEL). The solid-state laser comprises a solid-state laser medium (11) arranged in a laser cavity which consists oftwo resonator cavitymirrors (10, 12), a first of saidcavity mirrors (12) being designed as an outcoupling mirror of saidsolid-state 5 laser and a second of saidcavity mirrors (10) being formed to allow optical pumping of saidsolid-state laser medium (11) through saidsecond cavity mirror (10). In the proposed solid-state laser system, the extended cavity mirror (7) of the VECSEL is constituted byone of the resonator cavity mirrors (10, 12) of the solid-state-laser. The proposed laser system provides an improved conversion efficiency and a highly 10 integrated design.

### FIELD OF THE INVENTION

The invention relates to a solid-state laser system constituted by a solid-state laser which is optically pumped by a vertical extended cavity surface emitting laser (VECSEL), said VECSEL including an extended cavity mirror and said solid-state laser comprising a solid-state laser medium arranged in a laser cavity which consists of two cavity mirrors, a first of said cavity mirrors being designed as an outcoupling mirror of said solid-state laser and a second of said cavity mirrors being formed to allow optical pumping of said solid-state laser medium through said second cavity mirror.

### BACKGROUND OF THE INVENTION

Diode pumped solid-state lasers (DPSSL) are widely used nowadays. The radiation of an edge emitting laser diode is used to pump a solid-state laser crystal in a separate resonator cavity. The efficiency of such diode pumped solid-state lasers is generally limited by the emission characteristics of the edge emitting diodes, which requires complicated optics to collimate the emission in the fast and slow axis and to match the mode of the solid-state laser.

In order to overcome the drawbacks of the complicated collimation optics, it is known to use a VECSEL to pump the solid-state laser. US 2006/0153261 Al discloses such a solid-state laser system for generating solid-state laser radiation at 620 nm. The Eu³⁺-doped solid-state laser medium is pumped through one of the cavity mirrors forming the laser cavity of the solid-state laser. A lens is used between the VECSEL and the solid-state laser so as to focus the pump beam through the resonator cavity mirror into the solid-state laser medium. Since, in contrast to edge emitting laser diodes, a VECSEL provides a rotationally symmetric beam profile, the mode matching between the VECSEL and the solid-state laser is facilitated and therefore allows a better conversion efficiency from the pump radiation to the emission of the solid-state laser.

### OBJECT AND SUMMARY OF THE INVENTION

It is an object of the present invention to provide a solid-state laser system with a VECSEL pumped solid-state laser, in which the conversion efficiency is further improved.

The object is achieved with the solid-state laser system as defined in claim 1. Advantageous embodiments of the proposed solid-state laser system are defined in the dependent claims or are described in the subsequent portions of the description.

The proposed solid-state laser system is constituted by a solid-state laser which is optically pumped by a vertical extended cavity surface emitting laser (VECSEL). The solid-state laser comprises a solid-state laser medium arranged in a laser cavity which consists of two resonator cavity mirrors. A first of said cavity mirrors is designed as an outcoupling mirror of the solid-state laser, i.e. this mirror allows transmission of the laser radiation generated by the solid-state laser medium with a transmissivity of some %. The second of said cavity mirrors is formed to allow optical pumping of the solid-state laser medium through this second cavity mirror. This second cavity mirror is therefore designed to be highly reflective to the laser radiation of the solid-state laser, but allows transmission of the laser wavelength of the pump radiation generated by the VECSEL to a high degree. The solid-state laser system according to the present invention is characterized in that the extended mirror of the VECSEL is constituted by one of the resonator cavity mirrors of the solid-state laser.

This means that one of the components of the VECSEL is shared with one of the components of the solid-state laser, leading to a higher integration of the solid-state laser system. Due to this higher integration with the shared components, an improved mode matching is achieved, which results in a significant increase of conversion efficiency.

In the proposed solid-state laser system, the extended cavity mirror may consist of the first cavity mirror or of the second cavity mirror of the solid-state laser. If the extended cavity mirror consists of the second cavity mirror of the solid-state laser, which is the mirror partly transmissive to the pump radiation, the extended cavity of the VECSEL and the resonator cavity of the solid-state laser are arranged back to back, sharing one mirror component.

The compactness of the construction can be further improved if the second cavity mirror of the solid-state laser cavity, which is also the extended cavity mirror of the VECSEL, is directly attached to an end face of the solid-state laser medium of the solid-state laser. This laser medium is commonly constituted by a doped laser crystal or a doped glass body with polished end faces. As a preferred alternative, the second cavity mirror and the extended cavity mirror are constituted by an appropriate dielectric coating, in particular a multilayer coating, on the above end face of the solid-state laser medium. This precludes the use of any further substrate which has to be attached to this end face.

Furthermore, the first cavity mirror of the solid-state laser cavity may be formed by an appropriate coating on the opposite end face of the solid-state laser medium. This results in a solid-state laser which is composed of the solid-state laser medium with appropriate coatings on its two end faces, which coatings form the two resonator cavity mirrors of the solid-state laser. The end face carrying the first cavity mirror is preferably convexly shaped to form a convex first cavity mirror.

In a further embodiment, the solid-state laser is arranged inside the extended cavity of the VECSEL. In this embodiment, the extended mirror of the VECSEL also constitutes the first cavity mirror of the solid-state laser. The second cavity mirror of the solid-state laser is arranged inside the extended cavity of the VECSEL and is designed to be highly transmissive to the pump radiation of the VECSEL.

The design of the first and second resonator cavity mirrors of the solid-state laser appropriate to constitute the extended cavity mirror of the VECSEL at the same time is possible due to the different wavelengths of the VECSEL and the solid-state laser. Appropriate reflectivities and transmissivities for the different wavelengths can be achieved by an appropriate multilayer coating design as known in the art.

The proposed solid-state laser system is not limited to certain combinations of VECSEL laser materials or pump and emission wavelengths. Only for purposes of illustration, some examples are mentioned in the following description, which, however, do not limit the scope of the proposed invention. A well-known example of a solid-state laser is a Nd:YAG laser pumped at 808 nm and emitting at 1064 nm or 946 nm. Other examples are Yb:YAG, Yb:LaSc₃(BO₃)₄, or Yb:RE₂O₃ (RE=Y, Gd, Lu, Sc) for the solid-state laser material pumped at 970-980 nm and emitting, for example, at 1030 nm. Other examples are Er- and Er/Yb-doped materials such as, for example, Er:RE₂O₃ (RE=Y, Gd, Lu, Sc), Er:LaSc₃(BO₃)₄, Er:YAG, Er:YLF or Er/Yb:ZBLAN pumped at 970-980 nm and emitting at various wavelengths in the IR, e.g. at the telecom band around 1550 nm or at the maximum of water absorption at 2700 nm. Other materials are doped with trivalent Ce-, Pr-, Nd-, Pm-, Sm-, Eu-, Gd-, Tb-, Dy-, Ho-, Er-, Tm-, Yb- or doped with transition metal ions, which enlarge the range of accessible laser wavelengths for a VECSEL-pumped solid-state laser (VPSSL) to further wavelengths in the IR (1300 nm, 2000 nm, . . . ).

The VPSSL may also be of use for generating visible wavelengths. To give an example, a VECSEL emitting around 445 nm can be used to pump a Pr-doped material that is characterized by phonon energies below 600 cm⁻¹ and generates laser radiation at cyan (˜491 nm), green (˜520 nm), orange (˜610 nm) or red (˜640 nm) wavelengths. Some examples of suitable host materials are LiLuF₄, LiYF₄, KYF₄, KY₃F₁₀, BaY₂F₁₀, or ZBLAN. VPSSLs of this type are suitable laser sources for display applications.

In summary, pumped solid-state lasers as in the case of the proposed solid-state laser system will extend the range of wavelengths that are nowadays reachable with VECSEL technology to new wavelength ranges. For example, lasers emitting in the typical wavelength ranges used for fiber-optical communication, such as 1.3 or 1.5 μm, are possible. Also lasers emitting at the maximum of water absorption at 2.7 μm are possible on the basis of the proposed solid-state laser system. Such a system will therefore considerably enlarge a field of possible applications of VECSELs.

These and other aspects of the invention are apparent from and will be elucidated with reference to the embodiments described hereinafter.

### BRIEF DESCRIPTION OF THE DRAWINGS

The proposed solid-state laser system will be described hereinafter by way of example without limiting the scope of protection as defined by the claims. In the drawings,

FIG. 1 shows a typical setup of a VECSEL;

FIG. 2 shows a first example of the proposed solid-state laser system; and

FIG. 3 shows a second example of the proposed solid-state laser system.

### DESCRIPTION OF EMBODIMENTS

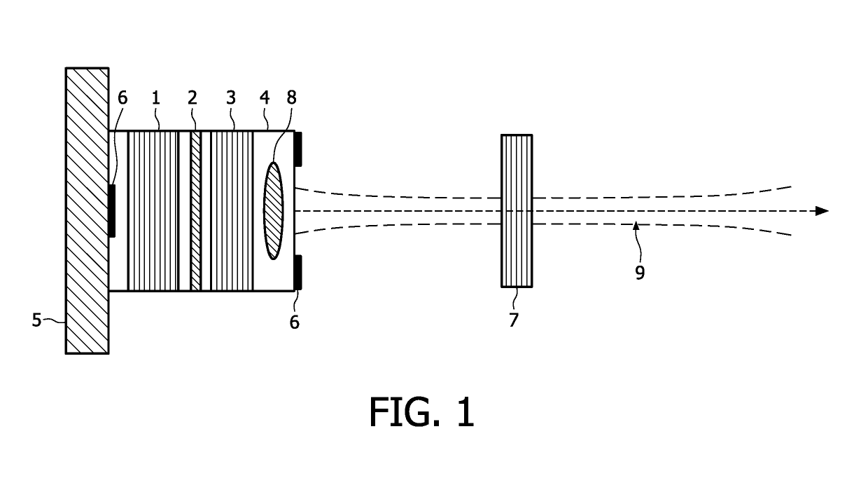

In contrast to edge emitting laser diodes, surface emitting lasers exhibit a symmetric and homogeneous beam profile. A special example of such a surface emitting laser is the VECSEL, which consists of a surface emitting laser with an extended cavity that defines and controls the mode of the laser. A sketch of a typical example of a VECSEL is shown in FIG. 1. The VECSEL comprises a layer stack forming a distributed Bragg reflector (DBR) 1, an active layer 2 and a partial DBR 3 on a substrate 4. The layer stack is mounted on a heat sink 5. Electrical pumping of the active layer 2 is achieved by appropriate electric contacts 6 applied on both sites of the layer stack. The extended cavity is formed between a separate extended mirror 7, which is designed as an outcoupling mirror of the VECSEL in this case, and the DBR 1 of the layer stack. Inside the substrate 4, a thermal lens 8 is formed due to heat generation during operation. With this thermal lens 8, a beam waist of the pump laser beam 9 is formed, in which the extended mirror 7 is placed. This extended mirror 7 provides the feedback for laser action. Instead or in addition to the thermal lens 8, a collimation lens can be formed in or on the substrate 4. Mode control in this VECSEL is possible by proper choice of the focal length of the thermal or collimating lens and by the design of the output coupler, i.e. of the extended cavity mirror 7. The general construction of such a VECSEL is known in the art.

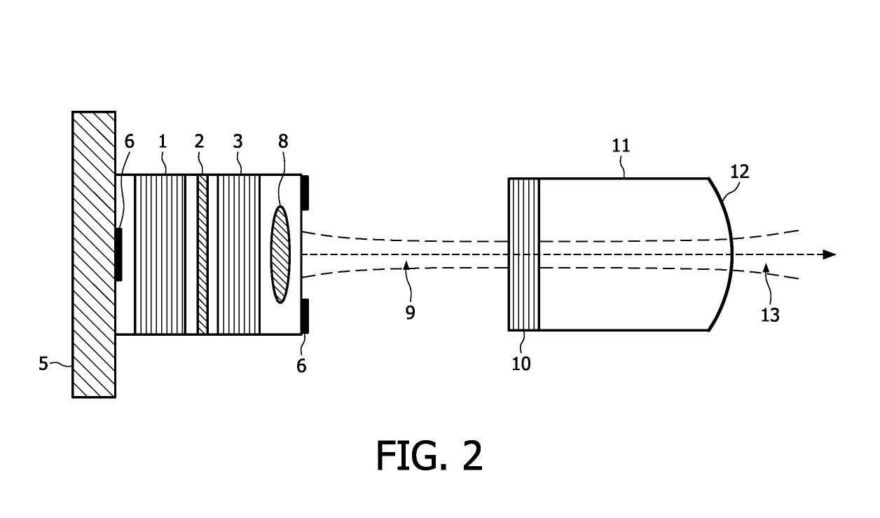

In the proposed solid-state laser system, such a VECSEL may be used as the pump laser for the solid-state laser. According to the present invention, the extended cavity mirror 7 of the VECSEL is formed by one of the resonator end mirrors of the solid-state laser. A first example of such a construction is shown in FIG. 2. In this special embodiment, the second cavity mirror 10 of the solid-state laser is directly attached to the solid-state laser medium 11 at one of its end faces. This second cavity mirror 10, which is highly reflective to the laser emission of the solid-state laser (laser beam 13), also constitutes the extended cavity mirror 7 of the VECSEL. This mirror can also be formed without any substrate directly on the end face of the solid-state laser medium 11.

In the proposed solid-state laser device, as shown, for example, in FIG. 2, no collimating lens is used between the pump laser and the solid-state laser. This precludes additional losses and results in a highly integrated construction. In an advantageous embodiment as shown in FIG. 2, the opposite end face of the solid-state laser medium 11 is coated to form the first end mirror 12 of the solid-state laser cavity, which is the output coupler for the solid-state laser. In this example, this opposite end face of the solid-state laser medium 11 is convexly shaped to form a hemispherical resonator for the solid-state laser. The construction described above results in a high degree of integration, in which the number of single optical elements that need to be aligned is not higher than is required for the VECSEL itself.

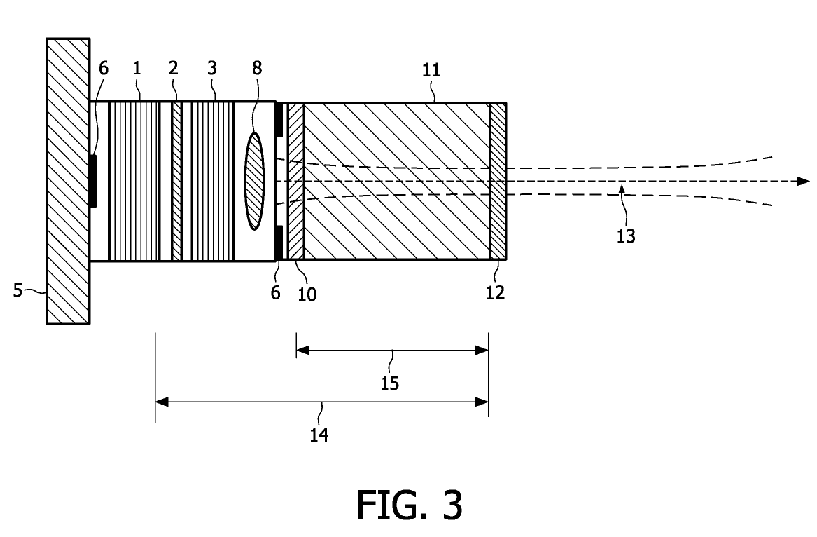

An even higher degree of integration can be achieved when the solid-state laser is placed within the extended cavity of the VECSEL, as depicted in FIG. 3. This setup has the additional advantage that the much higher intracavity power can be used for pumping the solid-state laser and, consequently, the solid-state laser can be pumped much higher above threshold. In this embodiment, the output coupler, i.e. first cavity mirror 12 of the solid-state laser, is designed to be highly reflective to the pump power so that the only losses to the pump laser are given by the absorption in the solid-state laser medium 11. At the same time, this first cavity mirror 12 of the solid-state laser forms the extended cavity mirror 7 for the VECSEL. In this case, the first cavity mirror 12 may even be a properly coated surface of the solid-state laser medium 11 or a component directly attached to the laser medium 11 instead of a separate optical component, which further reduces the number of components and alignment steps needed for such a laser.

The second cavity mirror 10 of the solid-state laser is also placed inside the extended cavity and may be attached to the layer stack forming part of the VECSEL. This second cavity mirror is designed to be highly transmissive to the pump radiation of the VECSEL and highly reflective to the converted radiation, i.e. the radiation emitted by the solid-state laser. In FIG. 3, the length 14 of the pump laser cavity and the length 15 of the solid-state laser cavity are also indicated.

The invention has been illustrated and described in detail in the drawings and the foregoing description by way of example and is not limited to the disclosed embodiments. Different embodiments described above and in the claims can also be combined. Other variants of the disclosed embodiments can be understood and effected by those skilled in the art in practicing the claimed invention, from a study of the drawings, the disclosure and the appended claims. For example, the construction of the VECSEL is not limited to that shown in the Figures. Also other constructions of such a VECSEL, for example, a VECSEL having the substrate on the other side of the layer stack may be used. Furthermore, the invention is not limited to any materials or sequences of layers of the stack of the VECSEL forming the DBRs and the active layer. The invention is neither limited to embodiments in which the resonator cavity mirrors are directly attached to or formed as coatings on the end faces of the solid-state medium. These cavity mirrors may also be arranged separately and away from the solid-state medium.

In the claims, use of the verb “comprise” and its conjugations does not exclude other elements or steps, and the indefinite article “a” or “an” does not exclude a plurality. The mere fact that measures are recited in mutually different dependent claims does not indicate that a combination of these measures cannot be used to advantage. Any reference signs in the claims shall not be construed as limiting the scope of these claims.

### LIST OF REFERENCE NUMERALS

1 DBR

2 active layer

3 partial DBR

4 substrate

5 heat sink

6 electric contacts

7 extended cavity mirror

8 thermal lens or collimation lens

9 pump laser beam

10 second end mirror

11 solid-state laser medium

12 first end mirror

13 solid-state laser beam

14 length of pump laser cavity

15 length of solid-state laser cavity

1. A solid-state laser system constituted by a solid-state laser which is optically pumped by a vertical extended cavity surface emitting laser, said vertical extended cavity surface emitting laser including an extended cavity mirror, and said solid-state laser comprising a solid-state laser medium arranged in a laser cavity which consists of two resonator cavity mirrors, a first of said cavity mirrors being designed as an outcoupling mirror of said solid-state laser and a second of said cavity mirrors being formed to allow optical pumping of said solid-state laser medium through said second cavity mirror, wherein said extended cavity mirror is constituted by one of the resonator cavity mirrors of said solid-state laser.

2. The device according to claim 1, wherein said extended cavity mirror is constituted by the second cavity mirror of said solid-state laser.

3. The device according to claim 2, wherein said extended cavity mirror and said second cavity mirror are constituted by a coating on a first end face of said solid-state laser medium.

4. The device according to claim 2, wherein said extended cavity mirror and said second cavity mirror are formed on a substrate which is attached to a first end face of said solid-state laser medium.

5. The device according to claim 3, wherein said first cavity mirror is constituted by a coating on a second end face of said solid-state laser medium opposite said first end face.

6. The device according to claim 5, wherein said second end face is convexly shaped.

7. The device according to claim 1, wherein said solid-state laser is arranged inside the extended cavity of said vertical extended cavity surface emitting laser, said extended cavity mirror being constituted by the first cavity mirror of said solid-state laser.

8. The device according to claim 1, wherein said VECSEL comprises a thermal lens or an integrated lens to form a beam waist of pump radiation at said extended cavity mirror.
